(19) United States
(12) Patent Application Publication
(10) Pub. No.: US 2007/0159048 A1
(43) Pub. Date: Jul. 12, 2007

(54) SHADOW MASKS FOR FULL-COLOR PROCESS

(75) Inventors: Fan-Hsiu Chang, Miaoli City, Miaoli County 360 (TW); Chung-Wen Ko, Sijhih City, Taipei County 221 (TW); Shi-Hao Li, Banciao City, Taipei County 220 (TW); Ching-Ian Chao, Hsinchu County 310 (TW); Che-Jen Chen, Kaohsiung City 802 (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU OPTONICS CORP., Hsinchu (TW)

(21) Appl. No.: 11/381,366

(22) Filed: May 3, 2006

(30) Foreign Application Priority Data
Jan. 9, 2006 (TW) 95100752

(51) Int. Cl. H01J 29/80; B05C 11/11

(52) U.S. Cl. 313/403; 118/504; 313/402

(57) ABSTRACT

Shadow masks capable of full-color process of display elements are provided. An exemplary embodiment of a shadow mask comprises a main body having a plurality of openings formed therethrough. A plurality of recesses formed over the main body, located adjacent to the openings. In an exemplary embodiment, the recesses are respectively defined by a trench formed in the main body and the trench is integrated with the main body. In another exemplary embodiment, the recesses are defined by a plurality of ribs protruding over a surface of the main body.

### BACKGROUND OF THE INVENTION

1. Field of the Invention

The present invention relates to electroluminescent display device fabrication, and more particularly to a shadow mask for full-color process of display elements of an electroluminescent display.

2. Description of the Related Art

Recently, research and development of electroluminescent techniques has been undertaken in the field of self-emissive display devices. Compared with other emissive display devices, such as plasma display devices, electroluminescent display devices have advantages such as lower power consumption, reduced size and provides images of higher brightness and sharpness. Typically, a plurality of pixel arrays are defined over an electroluminescent display device by a plurality of intercrossing scan lines and data lines formed therein and may be coupled with light-emitting devices. The light-emitting devices can be, for example, organic light-emitting devices (OLEDs) and are driven by a driving circuit corresponding to each thereof.

Typically, an OLED is formed by a stacked film structure, comprising an organic material layer which is sandwiched by two electrodes, named as cathode and anode. The organic material layer further comprises a hole transport layer, a light-emitting layer, and an electron transport layer. When voltages are applied between the cathode and the anode, positive and negative charges emitted by these layers will recombine in the light-emitting layer to thereby emit light.

The color of the light emitted by an OLED depends on the organic light-emitting material used therein. Conventional full-color OLED displays include a plurality of pixels for emitting lights mainly comprising red, green, and blue (RGB) colors and is formed in a manner of pixel array. Full-color spectrum can be achieved by the mixing of these lights of different colors during operation.

Such an organic light-emitting layer for emitting light of a certain color is formed by a vacuum evaporation incorporating a shallow mask. Use of the shadow mask selectively reveals regions over an array substrate of an OLED device for vacuum evaporation processing, thereby forming organic light-emitting layers for emitting different colors, for example green, red and blue.

Nevertheless, during the vacuum evaporation process, the shadow mask directly contacts some structures over an array substrate, such as spacers formed thereon, to precisely control regions of vacuum evaporation. Particles from the clean room or a previously contacted containment substrate may possibly remain on the surface of the shadow mask and therefore ruin device elements formed over the array substrate due to direct contact therebetween.

FIG. 1 is a schematic diagram illustrating display devices formed over a substrate of an electroluminescent device damaged by particles remaining on a shadow mask in a related art vacuum evaporation.

Referring now to FIG. 1, during the vacuum evaporation, a substrate, for example an array substrate 100, is first provided, having components such as gate lines and data lines for functioning signal lines, and thin film transistors (TFTs) formed thereon. The array substrate 100 in FIG. 1 is illustrated as a planar substrate merely for simplicity. As shown in FIG. 1, a plurality of spaces 110 are formed over the array substrate 100, defining a plurality display regions 120, 130 and 140 thereon, wherein the display regions 120, 130 and 140 are regions for forming display units of emitting lights of different colors.

As shown in FIG. 1, a transparent electrode 150 is respectively formed over the array substrate 100 in each of the display regions 120, 130 and 140. The vacuum evaporation (not shown) is repeatedly performed incorporation with a shadow mask 200 to form an organic light-emitting layer for emitting a light of a predetermined color in each of the display regions 120 and 140, such as the organic light-emitting layer 160 for emitting a light of red color in the display region 120 and the organic light-emitting layer 170 for emitting a light of green color in the display region 140, respectively.

Still referring to the FIG. 1, the shadow mask 200 is used again to form an organic light-emitting layer 170 for emitting a light of blue color by another vacuum evaporation (not shown). As illustrated, the shadow mask 200 is now exposed with an opening 210 substantially aligning to the display region 130 and a main body 205 thereof directly contacts the spacers 110 formed over the array substrate 100.

Nevertheless, the shadow mask 200 directly contacts the array substrate 100 at a side having a planar surface thereof, therefore particles came from the ambient of the clean room or a contaminant substrate which previously contacted with the shadow mask inevitably remains on the shadow mask and protrudes over the surface thereof. The particles are now illustrated as a particle 300 in FIG. 1 for illustration, the particle 300 now remains on the surface of the array substrate 100 that directly contacts the shadow mask 200. As shown in FIG. 1, since the particle 300 protrudes over the main body 205 of the shadow mask 200 at a side directly contacting the array substrate 100. Thus, the particle 300 directly contacts the organic light-emitting layer 170 previously formed in the display region 140 during the formation of the organic light-emitting layer 180 for emitting a light of blue color in the vacuum evaporation and thereby damages the planar surface in the display region 140, such that the device reliability in the display region 140 is affected.

Thus, the particles remaining and protruding over the shadow mask may repeatedly damage display units in certain display regions during the vacuum evaporation, thereby affecting the image performance of an ultimately formed display device. Therefore, an improved shadow mask design is needed to prevent the above mentioned image performance issues generated by the undesired particles which may remain on the shadow mask.

### BRIEF SUMMARY OF THE INVENTION

Shadow masks capable of full-color process of display elements are provided. An exemplary embodiment of a shadow mask comprises a main body having a plurality of openings formed therethrough. A plurality of recesses formed over the main body, located adjacent to the openings.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating a display device over an array substrate ruined by a particle remaining over a surface of a shadow mask in a related art vacuum evaporation;

FIG. 2 is a schematic top view showing a part of a shadow mask according to an embodiment of the invention;

FIG. 3 is a schematic cross section taken along line 3-3 of FIG. 2;

FIG. 4 is a schematic view showing the shadow mask of FIG. 2 performed in a fall-color process;

FIG. 5 is a schematic top view showing a part of a shadow mask according to another embodiment of the invention;

FIG. 6 is a schematic cross section taken along line 6-6 of FIG. 5; and

FIG. 7 is a schematic view showing the shadow mask of FIG. 5 performed in a fall-color process.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

FIGS. 2-7 illustrate exemplary embodiments of the invention. Referring now to FIG. 2, a top view of a part of a shadow mask 600 is illustrated. The shadow mask 600 includes a main body 605 comprised of, for example, Invar alloy, stainless steel (e.g. SUS 304, 420, 430), nickel or alloys of nickel and cobalt. A plurality of openings 700 is formed in the main body 605. The openings 700 are arranged with a predetermined spacing over the shadow mask 600 and formed through the main body 605, exposing regions for vacuum evaporation. The arrangement of the openings 700 can be modified and is not limited to the arrangement illustrated in FIG. 2. In FIG. 2, a plurality of recesses 620 are formed in portions of the main body 605 between the openings 700 to thereby accommodatr particles which may remain on a surface of the main body 605, thus preventing particle issues of the related art.

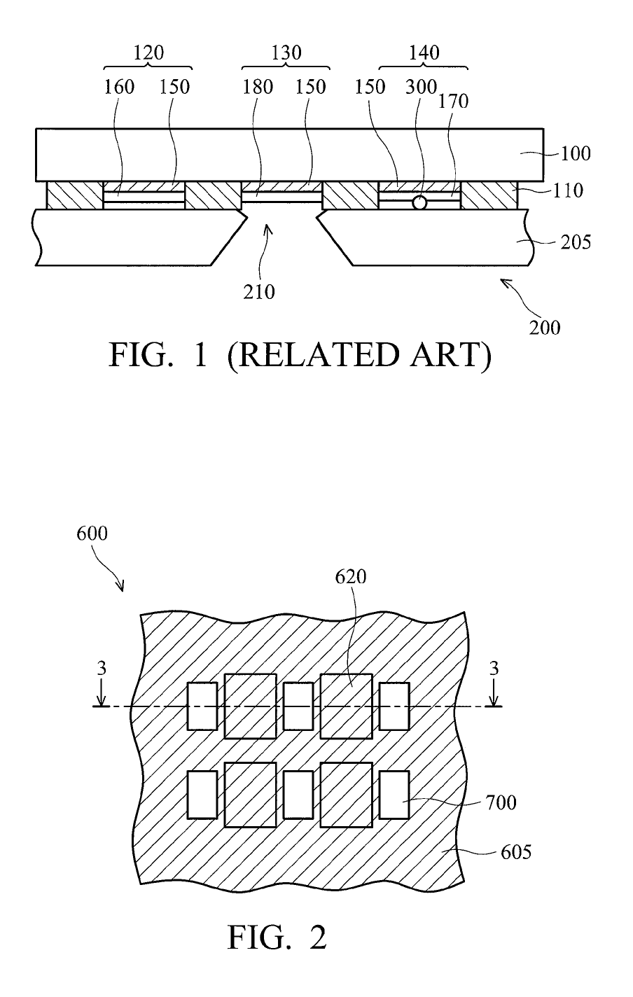

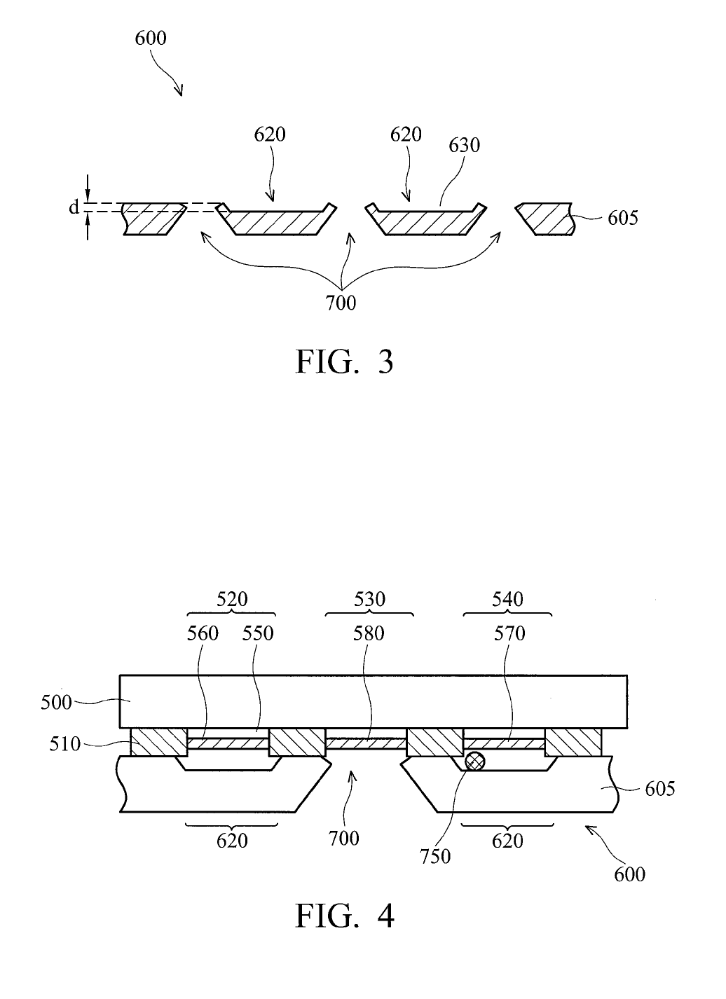

Referring now to FIG. 3, a cross section taken along line 3-3 of FIG. 2 is illustrated. As shown in FIG. 3, the recesses 620 are formed in a part within the main body 605 by trenches 630 formed by methods such as dry etching. Therefore, the main body 605 of the shadow mask 600 is now formed with an uneven surface which is different to the planar surface of the related art shadow mask illustrated in FIG. 1. The surface of the main body 605 is now formed with a plurality of recesses 620. As shown in FIG. 3, the trenches 630 have a depth of about 2-10 μm from the top surface of the main body 605. As observed by the inventors, particles from the ambient of a clean room and a previously contacted contaminated array substrate typically have a diameter of not more than 2 μm, the trenches 630 formed in the main body 605 can thus accommodate particles and thereby prevent protrusion thereof over the surface of the main body 605.

FIG. 4 is a schematic diagram showing the shadow mask 600 of FIG. 2 performed in a full-color process.

Referring now to FIG. 4, the fall-color process is illustrated as a vacuum evaporation and the substrate being performed with the vacuum evaporation is an array substrate of an electroluminescent device, such as the array substrate 500 but are not limited thereto. Other full-color processes and substrates can be also adopted. The substrate 500 is provided with components such as gate lines and data lines for functioning signal lines, and thin film transistors (TFTs) formed thereon. However, the array substrate 500 in FIG. 4 is illustrated as a substrate with a planar surface merely for simplicity. As shown in FIG. 4, a plurality of spacers 510 are formed over the array substrate 500, defining a plurality display regions 520, 530 and 540 thereon, wherein the display regions 520, 530 and 540 are regions for forming display units of emitting lights of different colors.

As shown in FIG. 4, a transparent electrode 550 is respectively formed over the array substrate 500 in each of the display regions 520, 530 and 540. The vacuum evaporation (not shown) is repeatedly performed in corporation with the shadow mask 600 to form an organic light-emitting layer for emitting a light of a predetermined color in each of the display regions 520 and 540, such as the organic light-emitting layer 560 for emitting a light of red color in the display region 520 and the organic light-emitting layer 570 for emitting a light of green color in the display region 540, respectively.

Still referring FIG. 4, a full-color process for forming an organic light-emitting layer 580 for emitting light of blue color over a transparent electrode 550 in a display region 530 by incorporating the shadow mask 600 is illustrated. As shown in FIG. 4, the main body 605 the shadow mask 600 is now exposed with an opening 700 substantially aligning to the display region 530 and the main body 605 is now directly contacts the spacers 510 formed over an array substrate 500. The recesses 620 formed in the main body 605 now substantially align to adjacent display units, such as the display regions 520 and 540, respectively.

Since the recesses 620 are formed in the main body 605 adjacent to the opening 700, a side of the shadow mask 600 for directly contacting the array substrate 500 is now formed with an uneven surface. Thus, particles came from the ambient of the clean room or a contaminant substrate, such as the particle 750 here, which previously contacted the shadow mask inevitably remains on the shadow mask 600 are now properly accommodated by the recesses 620. The particle 750 is now remains on a top surface of the main body 605 and protrudes therefrom. Thus, the particle 750 does not contact the organic light-emitting layer 570 previously formed in the display region 540 during the formation the organic light-emitting layer 580 for emitting red light during the vacuum evaporation and thereby reliability of the display device formed in the display region 540 is ensured.

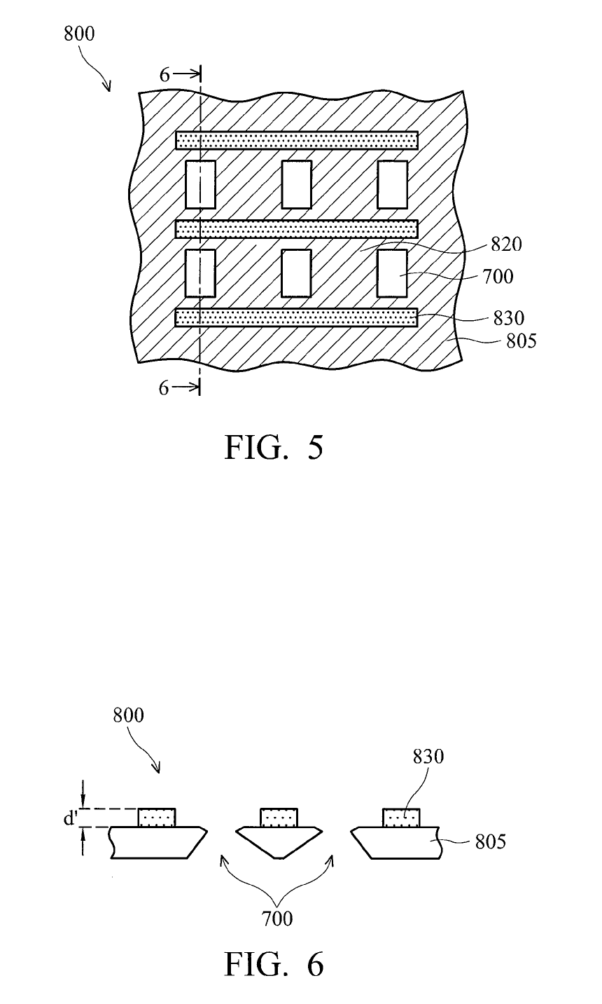

Referring now to FIG. 5, a top view of a part of a shadow mask 800 according to another exemplary embodiment is illustrated. The shadow mask 800 includes a main body 805 comprised of, for example, Invar alloy, stainless steel (e.g. SUS 304, 420, 430), nickel or alloys of nickel and cobalt. A plurality of openings 700 is formed in the main body 805. The openings 700 are arranged with a predetermined spacing over the shadow mask 800 and formed through the main body 605, exposing regions for vacuum evaporation. Arrangements of the openings 700 can be modified and is not limited to the situation illustrated in FIG. 5. In FIG. 5, a plurality of recesses 820 are defined over portions of the main body 805 between the openings 700 by forming a plurality of ribs 830 on both sides of the openings 700. The recesses 820 are capable of accommodating particles which may remain on a surface of the main body 805, thus preventing the shadow mask from particle issues of the related art.

As shown in FIG. 5, the recess 620 are formed over the main body 805 and are defined by the ribs 830 protruding over the surface of the main body adjacent to both sides of the openings 700. The side of the main body 805 for directly contacting the array substrate is now an uneven surface comprising a plurality of recesses and is different to the planar surface of the related art shadow mask illustrated in FIG. 1.

Referring now to FIG. 6, a cross section taken along line 6-6 of FIG. 5 is illustrated. As shown in FIG. 6, the recesses 620 have a depth d′ of about 2-10 μm and are substantially equal to a thickness of the ribs 830. As observed by the inventors, particles from the ambient of a clean room and a previously contacted contaminated array substrate typically have a diameter not more than 2 μm, the ribs 830 formed over the main body 805 can therefore define spaces for accommodating particles and thereby preventing protrusion thereof over the surface of the main body 805. Materials for forming the ribs 830 can be photosensitive materials such as resist and photosensitive polyimide and the ribs can be formed by method such as photolithography.

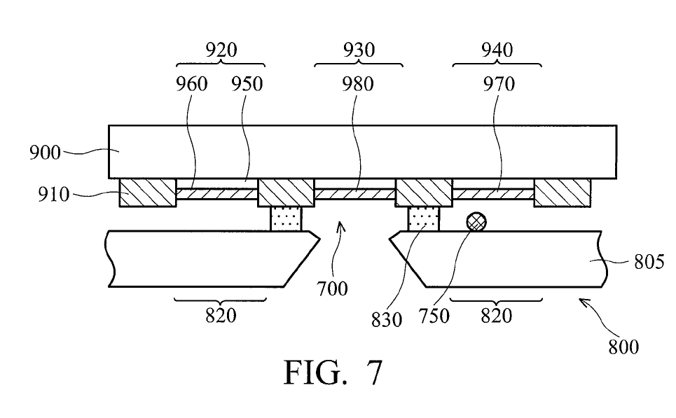

FIG. 7 is a schematic diagram showing the shadow mask 800 of FIG. 5 performed in a full-color process.

Referring now to FIG. 7, the full-color process is illustrated as a vacuum evaporation here and the substrate being performed with the vacuum evaporation is an array substrate of an electroluminescent device, such as the array substrate 900 but are not limited thereto. Other full-color processes and substrates can be also adopted. The substrate 900 is provided with components such as gate lines and data lines for functioning signal lines, and thin film transistors (TFTs) formed thereon. However, the array substrate 900 in FIG. 7 only illustrates a substrate with a planar surface, for simplicity. As shown in FIG. 7, a plurality of spacers 910 are formed over the array substrate 900, defining a plurality display regions 920, 930 and 940 thereon, wherein the display regions 920, 930 and 940 are regions for forming display units of emitting lights of different colors.

As shown in FIG. 7, a transparent electrode 950 is respectively formed over the array substrate 900 in each of the display regions 920, 930 and 940. The vacuum evaporation (not shown) is repeatedly performed in corporation with the shadow mask 800 to form an organic light-emitting layer for emitting a light of predetermined color in each of the display regions 920 and 940, such as the organic light-emitting layer 960 for emitting a red light in the display region 920 and the organic light-emitting layer 970 for emitting a green light in the display region 940, respectively.

Still referring FIG. 7, a full-color process for forming an organic light-emitting layer 980 for emitting lights of blue color over a transparent electrode 950 in a display region 930 by incorporating the shadow mask 800 is illustrated. As shown in FIG. 7, the main body 805 the shadow mask 800 is now exposed with an opening 700 substantially aligning to the display region 930 and the ribs 830 formed over the main body 805 now directly contacts the spacers 910 formed over an array substrate 900. The recesses 820 formed in the main body 805 now substantially align to adjacent display units, such as the display regions 820 and 840, respectively.

Since the recesses 820 are defined over the main body 805 adjacent to the opening 700 by the ribs 830 formed thereon, a side of the shadow mask 800 for directly contacting the array substrate 900 is now formed with an uneven surface. Thus, particles from the ambient of the clean room or a contaminant substrate, such as the particle 750 here, which previously contacted the shadow mask and inevitably remained on the shadow mask 800 are now properly accommodated by the recesses 820. The particle 750 now remains on a top surface of the main body 805 and protrudes thereof. Thus, the particle 750 does not contact the organic light-emitting layer 970 previously formed in the display region 940 during the formation the organic light-emitting layer 980 for emitting red light during the vacuum evaporation and thereby reliability of the display device formed in the display region 940 is ensured.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A shadow mask, capable of full-color process of display elements, comprising:
a main body having a plurality of openings formed therethrough; and
a plurality of recesses formed over the main body, located adjacent to the openings.

2. The shadow mask as claimed in claim 1, wherein the recesses are respectively defined by a trench formed in the main body and the trench is integrated with the main body.

3. The shadow mask as claimed in claim 1, wherein the recesses are defined by a plurality of ribs protruding over a surface of the main body.

4. The shadow mask as claimed in claim 3, wherein the main body comprises metal and the ribs comprise photosensitive materials.

5. The shadow mask as claimed in claim 3, wherein the main body has a planar surface and the ribs are formed thereon.

6. The shadow mask as claimed in claim 1, wherein each of the recesses accommodates at least one particle during full-color processing of the display elements and allows the particle not contacting the display elements.

7. The shadow mask as claimed in claim 1, wherein the recesses have a depth of 2 μm to 10 μm.

8. The shadow mask as claimed in claim 7, wherein the openings and the recesses align to display pixels of the display elements, respectively.
